(19) United States
(12) Patent Application Publication
(10) Pub. No.: US 2020/0033148 A1
(43) Pub. Date: Jan. 30, 2020

(54) Method and System for Optimizing Discounts in Ride-Sharing System

(71) Applicant: ANI Technologies Private Limited, Bengaluru (IN)

(72) Inventors: Gagandeep Singh, Bengaluru (IN); Mr. Vivek, Arwal (IN)

(21) Appl. No.: 16/518,324

(22) Filed: Jul. 22, 2019

(30) Foreign Application Priority Data
Jul. 25, 2018 (IN) 201841028046

(51) Int. Cl. G01C 21/34; G06Q 50/30; G06Q 10/02; G06Q 10/06; G06Q 50/18; G06N 5/02

(52) U.S. Cl. CPC G01C 21/3438; G06Q 50/30; G06N 5/022; G06Q 10/06; G06Q 50/188; G06Q 10/02

(57) ABSTRACT

A method and a system for ride-sharing are provided. A share-ride request including source and destination locations is received from a passenger device of a first passenger. A first score is determined based on at least one of historical or real-time signals associated with one or more routes including the source and destination locations. The first score indicates matching of the first passenger with at least a second passenger for the share-ride. A second score is determined based on a count of vehicles available for the share-ride. A share-ride discount for the share-ride is determined based on at least the first and second scores. The vehicle selected from the available vehicles is allocated to the first passenger for the share-ride. The selected vehicle is allocated based on a confirmation of a share-ride fare, including at least the share-ride discount, for the share-ride provided by the first passenger.

### CROSS-RELATED APPLICATIONS

This application claims priority of Indian Application Serial No. 201841028046, filed Jul. 25, 2018, the contents of which are incorporated herein by reference.

### FIELD OF THE INVENTION

The present invention relates generally to ride-sharing systems, and, more particularly, to a method and a system for optimizing discounts for share-rides requested by passengers in a ride-sharing system.

### BACKGROUND

Typically, passengers avail various public and private transportation services for commuting to and from their work places, or when the passengers are engaged in personal activities, such as intra-city or inter-city travel. While the public transportation services are still widely used, the private transportation services have gained prominence in the recent times. In modern cities, transport service providers play an important role in providing the private transportation services, such as cab services, to the passengers to travel to their desired destinations.

A passenger may avail the private transportation services by initiating a booking request for a ride by means of a software application or a web application (associated with a transport service provider such as OLA) installed on a computing device of the passenger. The vehicles are usually booked on individual basis, where the passenger travelling towards a destination location books a vehicle for a ride. When the vehicle is booked on individual basis, a ride fare for the requested ride is paid in full by the passenger. Also, with respect to such type of bookings, most of the vehicles tend to travel with minimum occupancy. Thus, in the event of an increased demand for the vehicle services at any given time, roads are crowded with the vehicles, which results in an increase in carbon dioxide (CO₂) emissions from the vehicles. Thus, various environmental problems, such as air pollution and global warming, have severely increased that are affecting the environment and daily lives of individuals. To overcome such problems, the transport service providers offer ride-sharing of a vehicle among two or more passengers. In such ride-sharing scenarios, two or more passengers can be allocated the same vehicle on shared-basis.

On shared-basis, the two or more passengers travelling along the same route (or different routes with minimum deviations) share the same vehicle. Thus, the number of vehicles that are operating on the roads at any given time instant may decrease, which may result in a decrease in the CO₂ emissions from the vehicles, and which may eventually reduce the adverse effects on the environment and the individuals. Further, when the bookings are made on shared-basis, the passenger has to spend less as compared to the scenario when the passenger books the vehicle on individual basis.

For a share-ride service, a share-ride fare, to be payable by the passenger for the share-ride, is determined by the transport service provider based on an assumption that the passenger will be matched with another passenger for sharing the same vehicle. However, there may be a scenario where the passenger is not matched with another passenger, and the passenger eventually ends up travelling alone in the vehicle. In such scenario, the passenger pays the share-ride fare (i.e., a discounted fare) for the share-ride even though there was no other passenger traveling along with her. Such instances may not be desirable for the transport service provider or a driver of the vehicle as it results in a loss of revenue for the transport service provider as well as the driver.

In light of the foregoing, there exists a need for a technical and more reliable solution that overcomes the above-mentioned problems and manages the share-ride fare payable by the passenger while allocating the vehicle to the passenger for the share-ride service such that the losses incurred by the transport service provider as well as the driver are optimized.

### SUMMARY

Various embodiments of the present invention provide a method and a system for optimizing share-ride fares in a ride-sharing environment. The method includes one or more operations that are executed by circuitry of the system for optimizing the share-ride fares in the ride-sharing environment. The circuitry receives a share-ride request for a share-ride from a passenger device of a first passenger over a communication network. The share-ride request includes at least source and destination locations for the share-ride. The circuitry determines a first score based on at least historical and real-time signals associated with one or more routes including the source and destination locations. The first score indicates matching of the first passenger with at least a second passenger for the share-ride. The historical signals include at least historical share-ride requests associated with the one or more routes. The real-time signals include at least one of real-time share-ride requests associated with the one or more routes, real-time traffic conditions associated with the one or more routes, or different time durations of a day. The circuitry determines a second score based on a count of vehicles that are available for the share-ride requested by the first passenger.

The circuitry determines a third score based on the first and second scores. The third score indicates matching of the first passenger with at least the second passenger for sharing a vehicle selected from the available vehicles. The circuitry determines a share-ride fare including at least a share-ride discount for the share-ride based on at least the third score. The share-ride discount is higher when the third score is greater than a threshold value in comparison to the share-ride discount when the third score is less than the threshold value. The share-ride discount may further be determined based on historical share-rides associated with the one or more routes. The share-ride discount may further be determined based on a count of share-ride demand. The share-ride discount is higher when the count of the share-ride demand is less than a target demand in comparison to the share-ride discount when the count of the share-ride demand is more than the target demand. The share-ride discount may further be determined based on the historical share-rides associated with different time durations of a day. The share-ride discount for a first time duration of the day is higher than the share-ride discount for a second time duration of the day when a count of the historical share-rides during the first time duration of the day is less than a count of the historical share-rides during the second time duration of the day.

The share-ride fare for the share-ride further includes a fixed ride fare for the share-ride. The fixed ride fare may be determined based on at least a distance between the source and destination locations and real-time traffic conditions between the source and destination locations. The real-time traffic conditions are determined based on sensor data received from at least one of location sensing devices or image sensing devices.

The circuitry renders a user interface on the passenger device that presents share-ride information of the share-ride including at least the share-ride fare. The user interface further presents various options, for example, first and second options that are selectable by the first passenger. The first option may be selected by the first passenger to confirm the share-ride fare for the share-ride. The second option may be selected by the first passenger to reject the share-ride fare for the share-ride. The circuitry allocates the selected vehicle to the first passenger for the share-ride based on confirmation of the share-ride fare for the share-ride provided by the first passenger i.e., by selecting the first option.

Thus, the method and the system of the present invention provide a choice to a transport service provider to optimize the overall discount, and in turn, the share-ride fare for the share-ride initiated by the first passenger. The share-ride fare including the discount is determined for the share-ride based on a probability of matching the first passenger with at least the second passenger for the share-ride, provided the vehicles are available for the share-ride. Hence, the first passenger will be charged for the share-ride based on the overall ride experience that the first passenger is about to receive during the share-ride, i.e., whether the first passenger will be travelling alone during the share-ride or will be matched with at least the second passenger. Further, such charging system for the share-ride may ensure that the transport service provider as well as a driver of the allocated vehicle do not incur losses while facilitating share-ride services to passengers. Thus, the method and the system of the present invention provide efficient and optimal way of charging the passengers for on-demand vehicle services in the ride-sharing environment.

### BRIEF DESCRIPTION OF THE DRAWINGS

The accompanying drawings illustrate the various embodiments of systems, methods, and other aspects of the invention. It will be apparent to a person skilled in the art that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice-versa.

FIG. 1 is a block diagram that illustrates an environment in which various embodiments of the present invention are practiced;

FIG. 2 is a block diagram that illustrates a passenger device and an application server of the environment of FIG. 1, in accordance with an embodiment of the present invention;

FIG. 3 is an exemplary environment in which passengers are matched for ride-sharing, in accordance with an embodiment of the present invention;

FIG. 4 is a block diagram that illustrates a user interface rendered on the passenger device, in accordance with an embodiment of the present invention;

FIGS. 5A and 5B, collectively, represent a flow chart that illustrates a method for determining a share-ride fare in a ride-sharing system, in accordance with an embodiment of the present invention; and

FIG. 6 is a block diagram that illustrates a computer system for determining the share-ride fare in the ride-sharing system, in accordance with an embodiment of the present invention.

Further areas of applicability of the present invention will become apparent from the detailed description provided hereinafter. It should be understood that the detailed description of exemplary embodiments is intended for illustration purposes only and is, therefore, not intended to necessarily limit the scope of the invention.

### DETAILED DESCRIPTION

As used in the specification and claims, the singular forms “a”, “an” and “the” may also include plural references. For example, the term “an article” may include a plurality of articles. Those with ordinary skill in the art will appreciate that the elements in the figures are illustrated for simplicity and clarity and are not necessarily drawn to scale. For example, the dimensions of some of the elements in the figures may be exaggerated, relative to other elements, in order to improve the understanding of the present invention. There may be additional components described in the foregoing application that are not depicted on one of the described drawings. In the event such a component is described, but not depicted in a drawing, the absence of such a drawing should not be considered as an omission of such design from the specification.

Before describing the present invention in detail, it should be observed that the present invention utilizes a combination of system components, which constitutes systems and methods for ride-sharing. Accordingly, the components and the method steps have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

### TERMS DESCRIPTION (In Addition to Plain and Dictionary Meaning)

Vehicle is a means of transport that is deployed by a transport service provider to provide vehicle services, such as on-demand cab services, to passengers. For example, the vehicle is an automobile, a bus, a car, a bike, or the like. The passengers may travel in the vehicle to commute between their source and destination locations.

Share-ride is a ride using a vehicle that may be shared by two or more passengers for travelling from source locations to their destination locations. The source and destination locations of the two or more passengers may be the same, along the same route, or along different routes.

Share-ride request is a request for a share-ride using a vehicle for travelling from one location to another location. A passenger initiates the share-ride request by means of a mobile or web application (associated with a transport service provider, such as OLA) installed on a computing device of the passenger. The share-ride request may include source and destination locations of the passenger. The share-ride request may further include a preference of the passenger that specifies a vehicle type, a pick-up time, a route type, a maximum fare, or the like.

First score is a numerical value that indicates a probability of matching a passenger, who has requested for a share-ride, with at least one other passenger for ride-sharing, provided at least one vehicle is available for the share-ride. The first score may be determined based on historical share-ride requests, real-time share-ride requests, real-time traffic conditions, different time durations of a day, or a combination thereof.

Second score is a numerical value that indicates a probability of availability of vehicles for a share-ride requested by a passenger. For example, if “n” vehicles are available, the second score is the probability that these “n” vehicles may service the passenger for the share-ride between source and destination locations specified by the passenger.

Third score is a numerical value that indicates a probability of matching a passenger with at least one other passenger for sharing a selected vehicle for a share-ride. The third score may be determined based on the first and second scores.

Image sensing device is a sensor and/or a device that detects and conveys information that includes one or more images captured by one or more image capturing devices. The image sensing or capturing devices may be installed along various road networks of a geographical area. The image capturing devices capture one or more images of the vicinity they are installed in, such as images of traffic conditions along the road networks. The image sensing device generates the information, for example, in the form of signals, based on the captured images, and transmits it to a remote server.

Location sensing device is a sensor that measures its position on the earth. The location sensing device may be integrated with a passenger device, a driver device, or a vehicle for measuring the position of the passenger device, the driver device, or the vehicle in a real-time. Based on real-time position information of passengers, drivers, vehicles, or a combination thereof, real-time traffic conditions along various road networks may be determined. The location sensing device may be an absolute position sensor or a relative one (i.e., a displacement sensor). Further, the location sensing device may be designed to measure linear positions, angular positions, multi-axis positions, or a combination thereof.

Share-ride demand is a demand for share-rides initiated by passengers for traveling between two or more locations in vehicles associated with a transport service provider. The share-ride demand may be determined based on a count of share-ride requests initiated by the passengers.

Fare is a service fee that is paid by a passenger for using vehicle services, for example, a cab that is provided by a transport service provider to the passenger for travelling between two or more locations.

Fixed ride fare is a fare that a passenger is charged for a ride using a vehicle service. The fixed ride fare may be determined based on a distance between source and destination locations of the passenger, a total time of travel between the source and destination locations, real-time traffic conditions along a route including the source and destination locations, or a combination thereof.

Share-ride discount is a discount that is given on a fixed ride fare if a passenger makes a booking for a ride on shared-basis. If the passenger books the ride on individual basis, then the passenger may end up paying the fixed ride fare in full. However, if the passenger opts for the share-ride, the passenger is given the share-ride discount on the fixed ride fare, and hence, ends up paying less than the fixed ride fare.

Share-ride fare is a fare for a share-ride that a passenger pays to a driver of a vehicle (or a transport service provider providing the vehicle) before or after completing the share-ride using the vehicle. The share-ride fare may be determined based on a fixed ride fare, a share-ride discount, or a combination thereof.

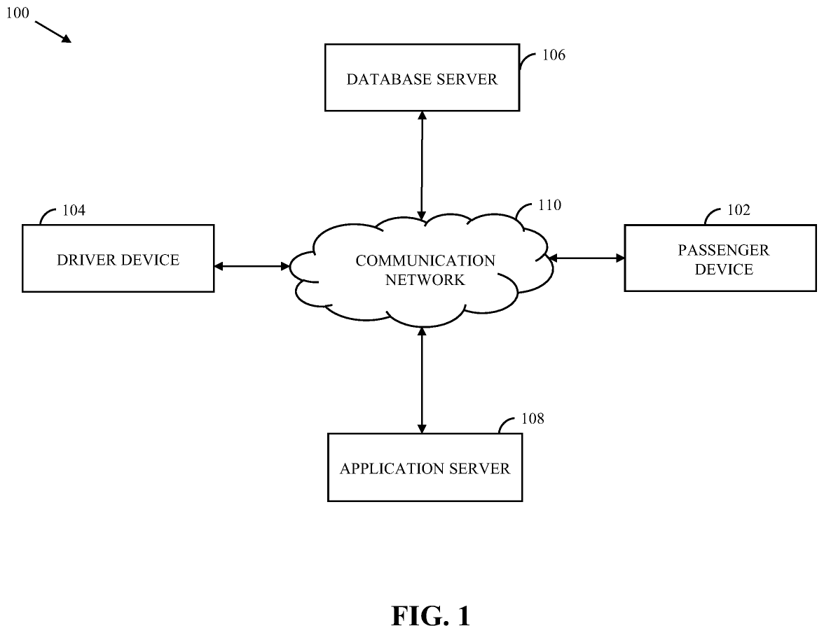

FIG. 1 is a block diagram that illustrates an environment 100 in which various embodiments of the present invention are practiced. The environment 100 includes a passenger device 102, a driver device 104, a storage server 106 (hereinafter, interchangeably referred to as “a database server 106”), and an application server 108 that communicate with each other by way of a communication network 110. Examples of the communication network 110 include, but are not limited to, a wireless fidelity (Wi-Fi) network, a light fidelity (Li-Fi) network, a satellite network, the Internet, a mobile network such as a cellular data network, a high-speed packet access (HSPA) network, or any combination thereof.

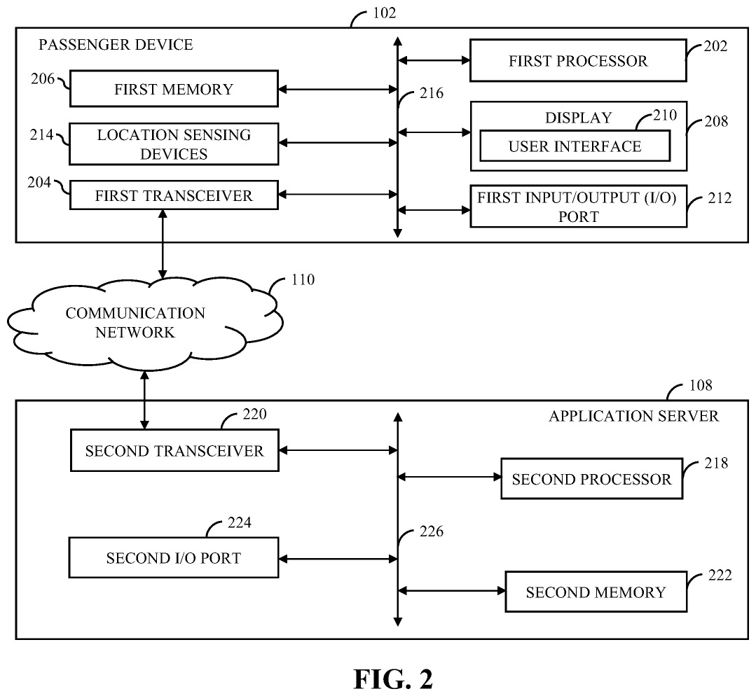

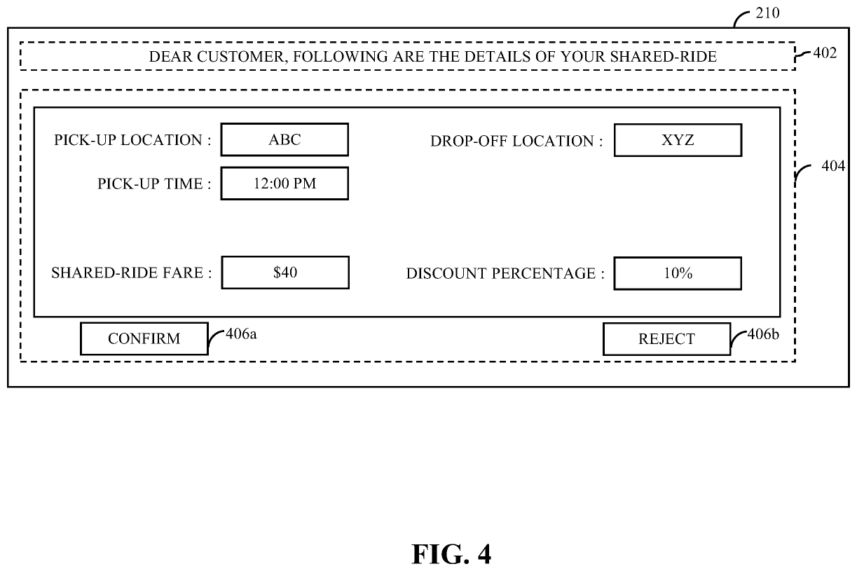

The passenger device 102 is a computing device that is used by a first passenger to perform various activities. For example, the first passenger uses a service application (associated with a transport service provider) installed on the passenger device 102 to initiate a first share-ride request for a share-ride. The various modes of input that can be used by the first passenger to initiate the first share-ride request may include, but are not limited to, a touch-based input, a text-based input, a voice-based input, a gesture-based input, or a combination thereof. To schedule the share-ride, the first passenger inputs details of the share-ride, for example, a first source location, a first destination location, a vehicle type, a time of travel, or the like, by means of the service application. The passenger device 102 further displays a user interface (shown in FIGS. 2 and 4), rendered by the application server 108 in response to the first share-ride request, by means of the service application. The user interface presents ride-related information, for example, a share-ride fare for the share-ride, a type of an available vehicle, or the like. The user interface also presents various options, such as first and second options, that are selectable by the first passenger. The first option allows the first passenger to accept the share-ride fare and confirm the share-ride. The second option allows the first passenger to reject the share-ride fare and cancel the share-ride. The first passenger uses the passenger device 102 for selecting one of the first and second options. The first passenger further uses the passenger device 102 to view allocation information including driver information, vehicle information, ride information, or the like provided by the application server 108 based on allocation of a vehicle to the first passenger for the share-ride. Examples of the passenger device 102 include, but are not limited to, a personal computer, a laptop, a smartphone, a tablet computer, and the like. The passenger device 102 has been described in detail in conjunction with FIG. 2.

The driver device 104 is a computing device that is used by a driver of a vehicle to perform various activities by means of a service application installed on the driver device 104. For example, the driver uses the driver device 104 to view an upcoming booking request (such as the first share-ride request) that has been received from the application server 108. The driver further uses the driver device 104 to accept or reject the received booking request, view route information provided by the application server 108 or a third-party server (not shown), and accordingly, follows directions to transport the passengers to their destination locations. For example, if the vehicle associated with the driver is allocated to the first passenger, the driver drives the vehicle and follows a route between the first source location and the first destination location to transport the first passenger from the first source location to the first destination location.

The driver device 104 transmits its location information, which in turn may indicate location information of the vehicle associated with the driver, to the application server 108. Further, the driver device 104 may transmit information, such as an availability status, a current booking status, a ride completion status, a pick-up time, a drop-off time, a ride fare, or the like, to the application server 108. The driver may further use the driver device 104 to view passenger information, allocation information, or the like. In an exemplary embodiment, the driver device 104 may be a vehicle head unit. In another exemplary embodiment, the driver device 104 may be an external communication device, such as a smartphone, a tablet, a laptop, or any other portable communication device, that is placed in the vehicle.

The database server 106 is a data management and storage server that is communicatively coupled with the communication network 110 for performing one or more database operations, such as receiving, storing, processing, and transmitting queries, data, or content, such as passenger information, driver information, vehicle information, booking information, allocation information, or the like. The queries, data, or content is received/transmitted from/to various components of the environment 100, such as the passenger device 102, the driver device 104, or the application server 108.

The database server 106 includes a processor (not shown) and a memory (not shown) for managing and storing historical travel data of the passengers or the drivers. The processor of the database server 106 may receive the historical travel data from passenger devices, such as the passenger device 102, driver devices, such as the driver device 104, and/or the application server 108 and stores the historical travel data in the memory of the database server 106. The historical travel data may include travel data of rides taken by the passengers in the past using various vehicles provided by the transport service provider. In an exemplary embodiment, the historical travel data of each passenger, such as the first passenger, may include at least historical source and destination locations, a frequency of historical rides between various source and destination locations, or a travel time of each historical ride (e.g., share and non-share ride). The processor of the database server 106 may determine the travel time of each historical ride based on a pick-up time (or a ride booking time) and a drop-off time of each historical ride. The historical travel data of the first passenger further includes historical preferences of the first passenger for one or more types of vehicles (for example, a ‘mini’, a ‘micro’, or a ‘prime’ vehicle type). The historical travel data further includes historical share-ride requests associated with one or more routes of various geographical areas. The database server 106 further stores historical allocation information corresponding to the historical share-ride requests.

Further, the database server 106 manages and stores the passenger information of the passengers and the driver information of the drivers. For example, the passenger information of each passenger may include at least a passenger name, a passenger contact number, or information pertaining to a passenger account of each passenger registered with the transport service provider. Similarly, the driver information of each driver may include at least a driver name, a registered vehicle make, a vehicle type, or information pertaining to a driver account of each driver registered with the transport service provider. In an embodiment, the processor of the database server 106 may generate a tabular data structure including one or more rows and columns for storing the information of the passengers (or the drivers) in a structured manner in the memory. For example, each row may be associated with a unique passenger identifier (ID) corresponding to each passenger, and one or more columns corresponding to each row may indicate the passenger name, the passenger ID, the historical source and destination locations, the frequency of historical rides between various historical source and destination locations, the travel time of each historical ride, or the historical preferences for the vehicles.

In an embodiment, the database server 106 may receive a query from the application server 108 over the communication network 110, to retrieve information such as the historical share-ride requests or historical share-rides associated with the one or more routes, the passenger information, the driver information, or the vehicle information. The database server 106, in response to the query, transmits the requested information to the application server 108 over the communication network 110. Examples of the database server 106 include, but are not limited to, a personal computer, a laptop, or a network of computer systems.

The application server 108 is a computing device, a software framework, or a combination thereof, that may provide a generalized approach to create the application server implementation. The operation of the application server 108 may be dedicated to execution of procedures, such as, but not limited to, programs, routines, or scripts stored in one or more memory units for supporting its applied applications. Examples of the application server 108 include, but are not limited to, a personal computer, a laptop, or a network of computer systems. The application server 108 may be realized through various web-based technologies such as, but not limited to, a Java web-framework, a .NET framework, a PHP (Hypertext Preprocessor) framework, or any other web-application framework.

In an embodiment, the application server 108 receives the first share-ride request, including the first source and destination locations, for the share-ride from the passenger device 102. The application server 108 transmits the query to the database server 106 to retrieve information, such as the historical share-ride requests or the historical share-rides, the passenger information, the driver information, or the vehicle information. Further, in an embodiment, the application server 108 determines a first score based on at least one of historical and real-time signals associated with the one or more routes. The historical signals include the historical share-ride requests associated with the one or more routes. The real-time signals include real-time share-ride requests associated with the one or more routes, real-time traffic conditions associated with the one or more routes, and different time durations of a day. The first score indicates a probability of matching the first passenger with at least one passenger for the share-ride. In an embodiment, the application server 108 further determines a second score based on a count of vehicles that are available for the share-ride. The second score indicates a probability of vehicles available for the share-ride. The application server 108 further determines a third score based on the first and second scores. The third score indicates a probability of matching the first passenger with at least one passenger for sharing a vehicle selected from the available vehicles. The determination of the first, second, and third scores has been described in detail in conjunction with FIG. 2.

The application server 108 further determines a share-ride discount based on the third score. The share-ride discount is higher when the third score is greater than a first threshold value in comparison to the share-ride discount when the third score is less than the first threshold value. The share-ride discount may further be determined based on at least one of the historical share-rides associated with the one or more routes, a count of share-ride demand, or the historical share-rides associated with different time durations of the day. The application server 108 further determines a share-ride fare for the share-ride based on the share-ride discount, a fixed ride fare, or a combination thereof. The fixed ride fare may be determined based on at least one of a distance between the first source and destination locations, a total time of travel between the first source and destination locations, the real-time traffic conditions between the first source and destination locations, or a combination thereof.

The application server 108 further renders the user interface on the passenger device 102 by means of the service application installed on the passenger device 102. The user interface may include various options that are selectable by the first passenger, the share-ride fare, the share-ride discount, the pick-up time, and the like. The first passenger may select an option to confirm the share-ride based on the share-ride fare or the share-ride discount. In response to confirmation of the share-ride by the first passenger, the application server 108 allocates the selected vehicle to the first passenger. In an embodiment, an allocation engine (not shown) hosted on the application server 108 may identify the selected vehicle for allocation and a pricing engine (not shown) hosted on the application server 108 may determine the share-ride fare. The various operations of the application server 108 have been described in detail in conjunction with FIGS. 2-4, 5A-5B, and 6.

FIG. 2 is a block diagram that illustrates the passenger device 102 and the application server 108, in accordance with an embodiment of the present invention. The passenger device 102 includes circuitry, such as a first processor 202, a first transceiver 204, a first memory 206, a display 208 for rendering a graphical user interface (GUI) such as a user interface 210, a first input/output (I/O) port 212, and location sensing devices 214, that communicate with each other by way of a first communication bus 216. The application server 108 includes circuitry, such as a second processor 218, a second transceiver 220, a second memory 222, and a second I/O port 224 that communicate with each other by way of a second communication bus 226. Examples of the first and second communication buses 216 and 226 include, but are not limited to, an industry standard architecture (ISA) bus, an extended industry standard architecture (EISA) bus, micro channel architecture (MCA) bus, peripheral component interconnect (PCI) bus, scalable coherent interface (SCI) bus, or any combination thereof

The first processor 202 includes suitable logic, circuitry, and/or interfaces that are operable to execute one or more instructions stored in the first memory 206 to perform one or more operations. For example, the first processor 202 transmits the first share-ride request to the second processor 218 by way of the first transceiver 204 over the communication network 110. The first processor 202 obtains the location information of the passenger device 102 by way of the location sensing devices 214 embedded in the passenger device 102. The first processor 202 further transmits the location information of the passenger device 102 to the second processor 218 by way of the first transceiver 204 over the communication network 110.

The first processor 202 displays one or more interfaces, such as the user interface 210, on the display 208 by means of the service application. The one or more interfaces are rendered by the second processor 218 by way of the first transceiver 204. The user interface 210 presents the share-ride fare in response to the received first share-ride request. The user interface 210 also presents the various options, such as the first and second options, that are selectable by the first passenger. The first option allows the first passenger to accept the share-ride fare and confirm the share-ride. The second option allows the first passenger to reject the share-ride fare and cancel the share-ride. The first passenger selects one of the first and second options by way of the first I/O port 212. The first processor 202 transmits the option selected by the first passenger to the second processor 218 by way of the first transceiver 204. Examples of the first processor 202 include, but are not limited to, an application-specific integrated circuit (ASIC) processor, a reduced instruction set computing (RISC) processor, a complex instruction set computing (CISC) processor, or a field-programmable gate array (FPGA) processor. It will be apparent to a person skilled in the art that the first processor 202 is compatible with multiple operating systems. It will further be apparent that the first processor 202 may be compatible with multiple displays, for example, the display 208.

The first transceiver 204 includes suitable logic, circuitry, and/or interfaces that are operable to transmit (or receive) data to (or from) various devices, such as the second transceiver 220, over the communication network 110. For example, the first transceiver 204 transmits inputs initiated by the first passenger, such as the first share-ride request and the selected option, to the second transceiver 220 over the communication network 110. The first transceiver 204 further transmits the location information of the passenger device 102 to the second transceiver 220. The first transceiver 204 further receives various instructions to render the one or more user interfaces, such as the user interface 210, including the share-ride fare, the various options selectable by the first passenger and the allocation information, from the second transceiver 220 over the communication network 110. Examples of the first transceiver 204 include, but are not limited to, an antenna, a radio frequency transceiver, a wireless transceiver, and a Bluetooth transceiver. The first transceiver 204 communicates with the communication network 110, the database server 106, and the second transceiver 220 using various wired and wireless communication protocols, such as TCPIP (Transmission Control Protocol Internet Protocol), UDP (User Datagram Protocol), 2^{nd} Generation (2G), 39^{rd} Generation (3G), 4^{th} Generation (4G), and 5^{th} Generation (5G) communication protocols, or any combination thereof.

The first memory 206 includes suitable logic, circuitry, and/or interfaces to store the one or more instructions that are executed by the first processor 202, the display 208, and the first I/O port 212, to perform the one or more operations. The first memory 206 stores the ride-related information, such as the share-ride fare and the allocation information. Examples of the first memory 206 include, but are not limited to, a random-access memory (RAM), a read-only memory (ROM), a programmable ROM (PROM), and an erasable PROM (EPROM).

The display 208 includes suitable logic, circuitry, and/or interfaces that are operable to execute one or more instructions stored in the first memory 206 to perform one or more display operations. For example, the display 208 displays one or more user interfaces, such as the user interface 210. In one example, the user interface 210 may be a booking interface that is used by the first passenger to initiate the first share-ride request for the share-ride. In another example, the user interface 210 may display the share-ride fare and various options selectable by the first passenger to confirm or cancel the share-ride. Examples of the display 208 include, but are not limited to, a thin film transistor liquid crystal display (TFT LCD), an in-plane switching (IPS) LCD, a Resistive Touchscreen LCD, a Capacitive Touchscreen LCD, an organic light emitting diode (OLED), an active-matrix organic light emitting diode (AMOLED), a Super AMOLED, a Retina Display, and a Haptic/Tactile touchscreen.

The first I/O port 212 includes suitable logic, circuitry, and/or interfaces that are operable to execute one or more instructions stored in the first memory 206 to perform one or more I/O operations. The first I/O port 212 may include input and output devices that are configured to operate under the control of the first processor 202 by way of the first communication bus 216. By way of the first I/O port 212, the first passenger provides one or more inputs to perform the one or more operations. For example, the first passenger may provide one or more inputs to open the service application on the passenger device 102, initiate requests for booking the share-ride, select one of the various options, and the like. Examples of the input devices may include a universal serial bus (USB) port, an Ethernet port, a real or virtual keyboard, a mouse, a joystick, a touch screen, a stylus, a microphone, and the like. Examples of the output devices may include the display 208, a speaker, headphones, a universal serial bus (USB) port, an Ethernet port, and the like.

The location sensing devices 214 are sensors that measure a position of the passenger device 102 in a real-time. The location sensing devices 214 transmit the location information regarding the position of the passenger device 102 to the first processor 202 by way of the first communication bus 216. The location sensing devices 214 may be absolute position sensors or relative position sensors (i.e., displacement sensors). The location sensing devices 214 may be designed to measure linear positions, angular positions, multi-axis positions, or a combination thereof.

The second processor 218 includes suitable logic, circuitry, and/or interfaces that are operable to execute one or more instructions stored in the second memory 222 to perform one or more operations. For example, the second processor 218 receives the first share-ride request from the first transceiver 204 by way of the second transceiver 220. In response to the received first share-ride request, the second processor 218 determines the share-ride fare. The second processor 218 renders the one or more interfaces, such as the user interface 210 and transmits the user interface 210 to the first transceiver 204 by way of the second transceiver 220. The second processor 218 further receives the option selected by the first passenger by way of the second transceiver 220. The second processor 218 allocates the selected vehicle to the first passenger based on the option selected by the first passenger. Examples of the second processor 218 include, but are not limited to, an ASIC processor, a RISC processor, a CISC processor, and an FPGA. It will be apparent to a person skilled in the art that the second processor 218 is compatible with multiple operating systems. The operations of the second processor 218 are described below in detail.

The second transceiver 220 includes suitable logic, circuitry, and/or interfaces that are operable to transmit (or receive) data to (or from) various devices, such as the first transceiver 204 over the communication network 110. For example, the second transceiver 220 receives the inputs initiated by the first passenger, such as the first share-ride request and the selected option, from the first transceiver 204. The second transceiver 220 transmits the various instructions to render the one or more interfaces, such as the user interface 210, to the first transceiver 204 over the communication network 110. The second transceiver 220 receives the location information of the passenger device 102 from the first transceiver 204. Examples of the second transceiver 220 include, but are not limited to, an antenna, a radio frequency transceiver, a wireless transceiver, and a Bluetooth transceiver. The second transceiver 220 communicates with the communication network 110, the database server 106, the second processor 218, and the first transceiver 204 using various wired and wireless communication protocols, such as TCPIP, UDP, 2G, 3G, 4G, and 5G communication protocols, or any combination thereof.

The second memory 222 includes suitable logic, circuitry, and/or interfaces to store the one or more instruction that are executed by the second processor 218 and the second I/O port 224 to perform the one or more operations. The second memory 222 stores the information retrieved from the database server 106. In addition, the second memory 222 stores the first share-ride request, the ride-related information, and the allocation information. Examples of the second memory 222 include, but are not limited to, a RAM, a ROM, a PROM, and an EPROM.

The second I/O port 224 includes suitable logic, circuitry, and/or interfaces that are operable to execute one or more instructions stored in the second memory 222 to perform one or more operations. The second I/O port 224 may include various input and output devices that are configured to operate under the control of the second processor 218 by way of the second communication bus 226. For example, by way of the second I/O port 224, an administrator associated with the application server 108 provides one or more inputs for initiating the one or more operations. Examples of the input devices may include a universal serial bus (USB) port, an Ethernet port, a real or virtual keyboard, a mouse, a joystick, a touch screen, a stylus, a microphone, and the like. Examples of the output devices may include a display screen, a speaker, headphones, a universal serial bus (USB) port, an Ethernet port, and the like.

Although the operations of FIGS. 1 and 2 describe the determination of the share-ride discount and then the determination of the share-ride fare, it will be apparent to a person having ordinary skill in the art that the second processor 218 can directly determine the share-ride fare based on the third score, the historical share-rides associated with the one or more routes, the count of share-demand, and the historical share-rides associated with different time durations of the day.

In operation, the first passenger provides the input to initiate the first share-ride request for the share-ride by means of the service application installed on the passenger device 102. The first share-ride request includes the first source and destination locations, the vehicle type, the time of travel, and the like. The first processor 202 transmits the first share-ride request to the second processor 218 by way of the first and second transceivers 204 and 220 over the communication network 110. The second processor 218 receives the first share-ride request and stores it in the second memory 222. The second processor 218 transmits the query to the database server 106 to retrieve the information such as the historical share-ride requests and the historical share-rides associated with the one or more routes including the first source and destination locations. In a scenario, the historical share-ride requests and the historical share-rides may be associated with source locations that are within a defined threshold distance of the first source location, and destination locations same as that of the first destination location. In another scenario, the historical share-ride requests and the historical share-rides may be associated with the source locations that are within the defined threshold distance of the first source location, and the destination locations along a route connecting the first source and destination locations. In yet another scenario, the historical share-ride requests and the historical share-rides may be associated with the source locations that are within the defined threshold distance of the first source location, and the destination locations are within a defined threshold distance of the first destination location.

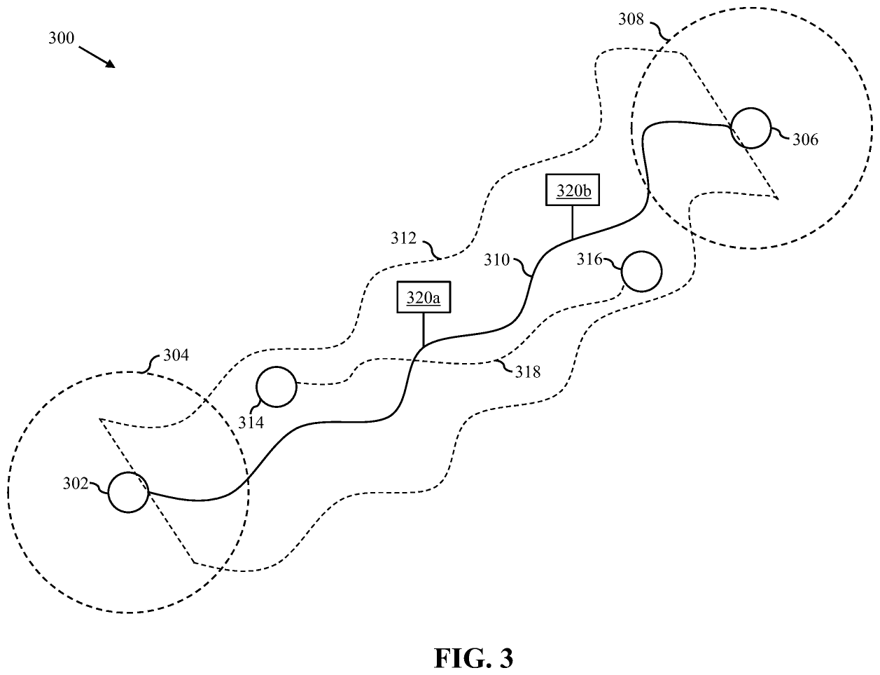

After receiving the first share-ride request, the second processor 218 determines the first score based on at least one of the historical and real-time signals associated with the one or more routes. The historical signals include the historical share-ride requests associated with the one or more routes. Each historical share-ride request is further associated with a pick-up time (or a booking time) that is after an approximate pick-up time (or a booking time) associated with the first share-ride request and before an approximate drop-off time of the first passenger to the first destination location. The real-time signals include the real-time share-ride requests associated with the one or more routes, the real-time traffic conditions associated with the one or more routes, and different time durations of a day. In one embodiment, the second processor 218 receives the real-time share-ride requests associated with the one or more routes from various passenger devices of various passengers registered with the transport service provider. The second processor 218 further receives the location information of the passengers and the drivers (i.e., first sensor data) from the passenger devices and the driver devices, respectively. The location information of the drivers may be the location information of the vehicles associated with the drivers. The second processor 218 further receives second sensor data from image sensing devices (shown in FIG. 3). The second processor 218 determines the real-time traffic conditions associated with the one or more routes based on the first and second sensor data.

To determine the first score, the second processor 218 identifies a second share-ride request from at least one of the historical and real-time share-ride requests. The second processor 218 then determines a first probability of matching the first passenger travelling from the first source location (s1) to the first destination location (d1) with a second passenger associated with the second share-ride request travelling from a second source location (s2) to a second destination location (d2), assuming at least one vehicle is available for travelling from the first source location (s1) to the first destination location (d1). The first probability of matching the first passenger with the second passenger is represented by “M_{c} (s1, d1, s2, d2)”.

The second processor 218, similarly, determines multiple probabilities of matching the first passenger with passengers corresponding to the historical or real-time share-ride requests. In an example, the multiple probabilities may include second through sixth probabilities. The second through sixth probabilities are probabilities of matching the first passenger travelling from the first source location (s1) to the first destination location (d1) with third through seventh passengers, respectively. The third through seventh passengers travel from third through seventh source locations to third through seventh destination locations, respectively. The second processor 218 further performs a summation of the first probability and the multiple probabilities to determine the first score. The second processor 218 determines the first score (“M_{c} (s1, d1)”) based on a first equation shown below:

M_{c}(s1, d1)=Σ_{s2,d2}(M_{c}(s1, d1, s2, d2)) (1)

The first score thus indicates the probability of matching the first passenger travelling from the first source location (s1) to the first destination location (d1) with at least one passenger for the share-ride, assuming at least one vehicle is available for travelling from the first source location (s1) to the first destination location (d1). An example of determination of the first score, i.e., the probability of matching the first passenger travelling from the first source location (s1) to the first destination location (d1) with at least one passenger for the share-ride, is explained in conjunction with FIG. 3.

The second processor 218 further determines the second score based on the count of vehicles that are available for the share-ride. In one embodiment, the second processor 218 identifies the vehicles that are available to service the first share-ride request based on the location information of the vehicles obtained from the first sensor data. The second score indicates the probability of vehicles available for the share-ride. The second score is directly proportional to the count of the available vehicles. For example, when the count of the available vehicles is greater than a second threshold value, the second score is higher, in comparison to when the count of the available vehicles is less than the second threshold value. The second score is indicated by the term “P(n, s1, d1)”, where, “n” is a count of the available vehicles, and “P(n, s1, d1)” indicates a probability that there are ‘n’ vehicles that can service the first passenger travelling from the first source location (s1) to the first destination location (d1).

The second processor 218 further determines the third score based on the first and second scores. The third score indicates a probability of matching the first passenger with at least one passenger for sharing the vehicle selected from the available vehicles. The application server 108 determines the third score (M (s1, d1) based on a second equation as shown below:

M(s1, d1)=Σₙ₌₁{P(n, s1, d1)*[1−(1−M_{c}(s1, d1))ⁿ]} (2)

where,
(1-M_{c}(s1, d1))ⁿ indicates a probability of not matching any passenger with the first passenger for the share-ride when ‘n’ vehicles are available; and
[1-(1-M_{c}(s1, d1))ⁿ] indicates a probability of matching the first passenger with at least one passenger for the share-ride when ‘n’ vehicles are available.

The third score may vary in a range of 0 to 1. In an example, the third score in the range of 0 to 0.4 indicates a low probability of matching the first passenger with at least one passenger for sharing the selected vehicle. Further, the third score in the range of 0.4 to 0.7 indicates a moderate probability of matching the first passenger with at least one passenger for sharing the selected vehicle. The third score in the range of 0.7 to 1 indicates a high probability of matching the first passenger with at least one passenger for sharing the selected vehicle.

The second processor 218 determines the share-ride discount based on the third score. In an example, the share-ride discount is higher when the third score is greater than the first threshold value in comparison to the share-ride discount when the third score is less than the first threshold value. For example, when the third score is greater than 0.5, the share-ride discount is higher than that in the scenario when the third score is less than 0.5. In another example, the share-ride discount is low when the third score is less than a third threshold value and the share-ride discount is high when the third score is greater than a fourth threshold value. For example, when the third score is greater than 0.7, the share-ride discount is higher than the share-ride discount for when the third score is less than 0.4. Further, when the third score is higher than the third threshold value and lower than the fourth threshold value, the second processor 218 determines first and second levels of share-ride discount. Thus, when the third score is in the range of 0.4 to 0.7, the second processor 218 determines the first and second levels of share-ride discount. The first level of share-ride discount is determined based on the third score. Since the third score is in the range of 0.4 to 0.7, the first level of share-ride discount is moderate as there is a moderate possibility of the first passenger matching with at least one passenger for sharing the selected vehicle. However, after the share-ride commences, if the first passenger is matched with a passenger, the second processor 218 determines the second level of share-ride discount. The second level of share-ride discount is higher than the first level of share-ride discount. Thus, the share-ride fare is determined based on the second level of share-ride discount.

The second processor 218 further considers the historical share-rides associated with the one or more routes for determining the share-ride discount. In an embodiment, if a second route has a count of the historical share-rides associated with the one or more routes greater than a fifth threshold value and a third route has a count of the historical share-rides associated with the one or more routes less than the fifth threshold value, the share-ride discount for the second route is higher as compared to the share-ride discount for the third route. Thus, in an exemplary scenario, if the second route and geographical areas associated with it have a count of historical share-rides less than the count of historical share-rides of the third route and geographical areas associated with it, the second processor 218 may determine a higher share-ride discount for the second route as compared to the share-ride discount for the third route. Thus, the passengers are encouraged to travel via the second route as opposed to the third route. In another embodiment, if the second route has the count of the historical share-rides associated with the one or more routes greater than the fifth threshold value and the third route has the count of the historical share-rides associated with the one or more routes less than the fifth threshold value, the share-ride discount for the second route is less as compared to the share-ride discount for the third route.

The second processor 218 further considers the count of share-ride demand for determining the share-ride discount. The share-ride discount is high when the count of the share-ride demand during a first time duration of the day is less than a target demand for the first time duration of the day. The share-ride discount is low when the count of the share-ride demand during the first time duration of the day is more than the target demand for the first time duration of the day. In an exemplary scenario, if the count of share-ride demand between 2 pm and 6 pm is less than the target demand between 2 pm and 6 pm, the second processor 218 may determine a higher share-ride discount to encourage the passengers to book more share-rides. Similarly, if the count of share-ride demand between 2 pm and 6 pm is more than the target demand between 2 pm and 6 pm, the second processor 218 may determine a lower share-ride discount.

The second processor 218 further considers the historical share-rides associated with the one or more routes during different time durations of the day while determining the share-ride discount. In an embodiment, when a count of the historical share-rides associated with the one or more routes during a second time duration of the day is less than a count of historical share-rides associated with the one or more routes during a third time duration of the day, the share-ride discount for the second time duration of the day is greater than the share-ride discount for the third time duration of the day. Thus, in an exemplary scenario, if the count of historical share-rides associated with the one or more routes between 2 pm and 6 pm is less than the count of historical share-rides associated with the one or more routes between 6 pm and 10 pm, the second processor 218 determines a higher share-ride discount between 2 pm and 6 pm as compared to the share-ride discount between 6 pm and 10 pm. In another embodiment, the share-ride discount for the second time duration of the day is greater than the share-ride discount for the third time duration of the day, when the count of the historical share-rides associated with the one or more routes during the second time duration of the day is greater than the count of historical share-rides associated with the one or more routes during the third time duration of the day.

The second processor 218 further determines the share-ride fare based on the share-ride discount, the fixed ride fare, or a combination thereof. The fixed ride fare may be determined based on the distance between the first source and destination locations, the total time of travel between the first source and destination locations, the real-time traffic conditions between the first source and destination locations, or a combination thereof. The fixed fare represents a fare that the first passenger is charged for the ride, if the first passenger makes the booking for the ride on individual basis. In an embodiment, the share-ride fare is equal to the share-ride discount. In another embodiment, the share-ride fare is equal to a difference between the fixed ride fare and the share-ride discount.

The second processor 218 further renders the user interface 210 on the passenger device 102 by means of the service application. The user interface 210 may include the various options, such as the first and second options, selectable by the first passenger, the share-ride fare, the share-ride discount, the pick-up time, and the like. The first option allows the first passenger to accept the share-ride fare and confirm the share-ride. The second option allows the first passenger to reject the share-ride fare and cancel the share-ride. The first passenger may select an option to confirm the share-ride based on the share-ride fare or the share-ride discount. In response to selection, the application server 108 allocates the selected vehicle to the first passenger.

FIG. 3 is an exemplary environment 300 in which passengers are matched for ride-sharing, in accordance with an embodiment of the present invention. The second processor 218 receives the first share-ride request from the passenger device 102 of the first passenger for the share-ride. The first share-ride request includes the first source location 302 located in a first geographical area 304 and the first destination location 306 located in a second geographical area 308. Based on the first source location 302 and the first destination location 306, the second processor 218 identifies the one or more routes, for example, a fourth route 310. Further, the second processor 218 checks for the real-time share-ride requests associated with the fourth route 310. Further, the second processor 218 retrieves the historical share-ride requests associated with the fourth route 310 from the database server 106.

A third share-ride request including an eighth source location and an eighth destination location associated with the fourth route 310 may further be identified, if the eighth source location is located in the first geographical area 304 and the eighth destination location is located in the second geographical area 308. In another embodiment, the third share-ride request associated with the fourth route 310 may be identified, if the eighth source and destination locations are in a vicinity of the fourth route 310. The vicinity of the fourth route 310, which is considered for matching the passengers, may defined by an administrator of the transport service provider, for example, as shown by a third geographical area 312. In an example, the third geographical area 312 extends to 2 kilometers (km) on both sides of the fourth route 310. Further, the third share-ride request is considered associated with the fourth route 310, if the eighth source location is located in the third geographical area 312 and the eighth destination location is located in the second geographical area 308. Further, the third share-ride request is considered associated with the fourth route 310, if the eighth source location is located in the first geographical area 304 and the eighth destination location is located in the third geographical area 312. Further, the third share-ride request is considered associated with the fourth route 310, if the eighth source location is located in the first geographical area 304 or if the third geographical area 312 and a fifth route connecting the eighth source and destination locations passes through the second geographical area 308. However, the third share-ride request is not considered associated with the fourth route 310, if at least one of the eighth source location or the eighth destination location is located outside the first through third geographical areas 304, 308, and 312, and a sixth route connecting the eighth source and destination locations does not pass through the first and second geographical areas 304 and 308.

The second processor 218 identifies from the historical or real-time share-ride requests associated with the fourth route 310, the second share-ride request, including the second source location 314, the second destination location 316, and a seventh route 318 connecting the second source and destination locations 314 and 316. In an example, the second share-ride request is specified by the second passenger. The second processor 218 determines the first probability of matching the first passenger with the second passenger for the share-ride. Similarly, the second processor 218 determines the multiple probabilities of matching the first passenger with passengers corresponding to the historical or real-time share-ride requests associated with the fourth route 310. The second processor 218 then determines the first score based on the first and multiple probabilities.

The fourth route 310 further includes multiple image sensing devices, such as closed-circuit television cameras (CCTV cameras), including first and second image sensing devices 320a and 320b. The first and second image sensing devices 320a and 320b capture images of the vicinity they are installed in, such as the images of traffic conditions along the road networks, and generate information in the form of signals. The information (i.e., the second sensor data) is used to determine real-time traffic conditions along the fourth route 310. It will be apparent to a person skilled in the art that the abovementioned exemplary environment 300 is for illustrative purpose and should not be construed to limit the scope of the invention.

FIG. 4 is a block diagram that illustrates the user interface 210 rendered on the passenger device 102, in accordance with an embodiment of the present invention. The user interface 210 is a user interface associated with booking of the share-ride. The user interface 210 includes one or more sections, such as a welcome message section 402 and a share-ride information section 404. The welcome message section 402 may display an appropriate welcome message and/or information (for example, “DEAR CUSTOMER, FOLLOWING ARE THE DETAILS OF YOUR SHARED-RIDE”).

The share-ride information section 404 includes pick-up and drop-off locations (i.e., the first source and destination locations, for example, “ABC” and “XYZ”, as shown), the pick-up time (for example, “12:00 PM”, as shown), the share-ride fare (for example, “$40”, as shown), and a discount percentage (for example, “10%”, as shown). The discount percentage is determined based on the share-ride discount and the share-ride fare. The share-ride information section 404 further includes ‘confirm’ and ‘reject’ tabs 406a and 406b. The ‘confirm’ tab 406a is selectable by the first passenger and allows the first passenger to accept the share-ride fare and confirm the share-ride based on the information presented in the share-ride information section 404. For example, the first passenger may select the ‘confirm’ tab 406a if the first passenger wishes to accept the share-ride fare presented and the vehicle selected for allocation. After receiving the passenger selection, the second processor 218 allocates the selected vehicle for the share-ride. The ‘reject’ tab 406b is selectable by the first passenger and allows the first passenger to reject the share-ride fare and cancel the share-ride based on the information presented in the share-ride information section 404. A person having ordinary skill in the art will understand that the user interface 210 may include various other sections apart from the share-ride information section 404. Further, it will also be apparent to a person skilled in the art that that the user interface 210 is one example of the one or more user interfaces and various other kinds of user interfaces may be presented on the passenger device 102.

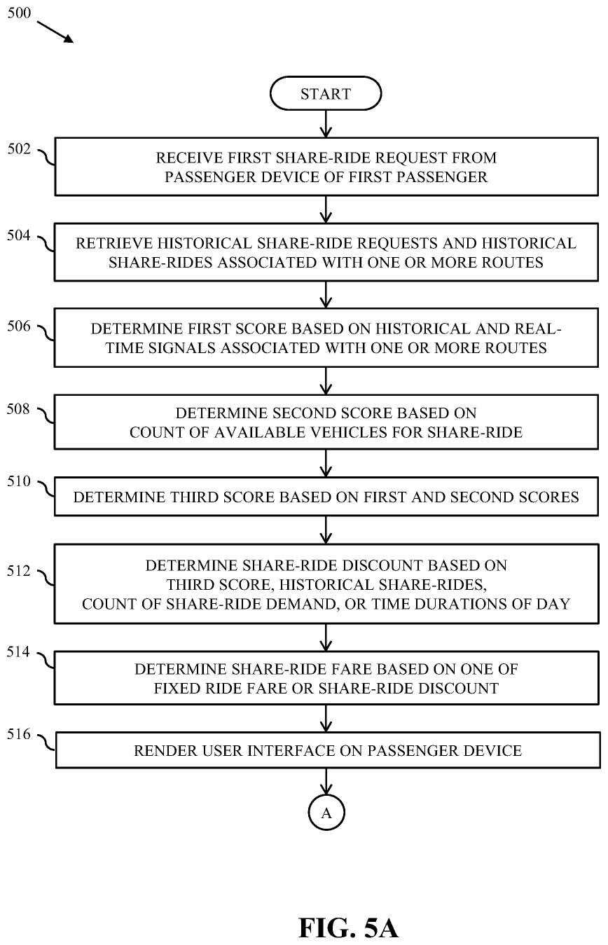

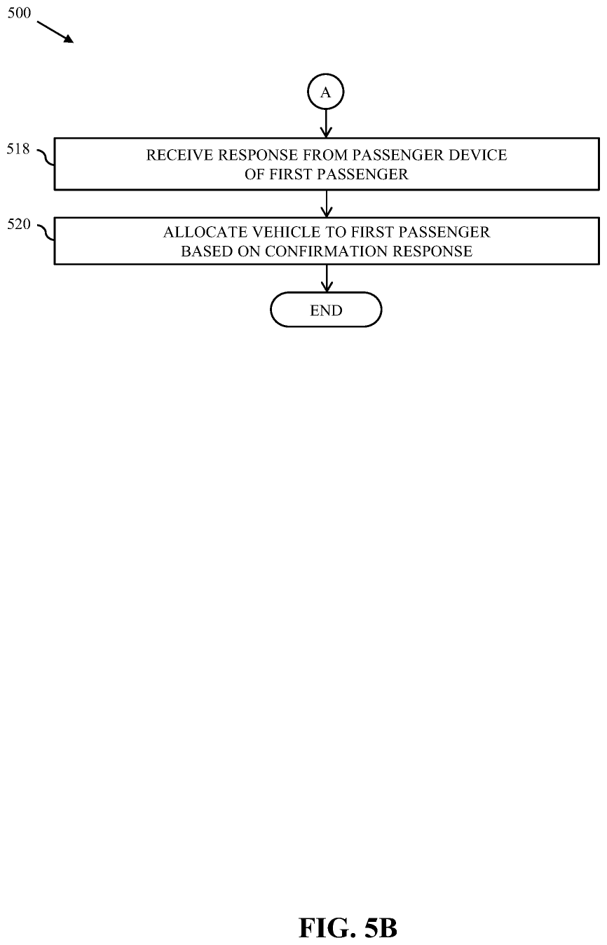

FIGS. 5A and 5B, collectively, represent a flow chart 500 that illustrates a method for determining the share-ride fare in a ride-sharing system, in accordance with an embodiment of the present invention. At step 502, the first share-ride request is received from the passenger device 102 of the first passenger. The first passenger provides the input to initiate the first share-ride request for the share-ride by means of the service application installed on the passenger device 102. The second processor 218 receives the first share-ride request by way of the second transceiver 220 over the communication network 110. The first share-ride request includes the first source and destination locations. In one example, Adam is the first passenger who provides the input to initiate the first share-ride request for the share-ride by means of the service application installed on his device. The first share-ride request includes the first source location ‘X’ and the first destination location ‘Y’.

At step 504, the information pertaining to the historical share-ride requests and the historical share-rides associated with the one or more routes are retrieved. The second processor 218 retrieves the information from the database server 106. In the example, the second processor 218 retrieves the information such as the historical share-ride requests and the historical share-rides associated with the one or more routes connecting the ‘X’ and ‘Y’ locations.

At step 506, the first score is determined based on the historical or real-time signals associated with the one or more routes. The historical signals include the historical share-ride requests associated with the one or more routes. The real-time signals include the real-time share-ride requests associated with the one or more routes, the real-time traffic conditions associated with the one or more routes, and different time durations of a day. To determine the first score, the second processor 218 identifies the second share-ride request from the historical or real-time share-ride requests associated with the one or more routes. The second processor 218 determines the first probability of matching the first passenger, with the second passenger associated with the second share-ride request. Similarly, the second processor 218 determines the multiple probabilities of matching the first passenger with passengers corresponding to the historical or real-time share-ride requests associated with the one or more routes. The second processor 218 further performs a summation of the first probability and the multiple probabilities to determine the first score. The first score indicates the probability of matching the first passenger with at least one passenger for the share-ride. In the example, Brad is the second passenger who had specified a share-ride request for the share-ride in the past. The share-ride request included source and destination locations located along an eighth route connecting the ‘X’ and ‘Y’ locations. The second processor 218 identifies the share-ride request (specified by Brad) as the second share-ride request and determines the first probability of matching Adam and Brad for the share-ride. Further, the historical or real-time share-ride requests associated with the one or more routes connecting the ‘X’ and ‘Y’ locations include the share-ride requests from Cam, Dan, Eric, Fred, and James. The second processor 218 determines the second through sixth probabilities based on share-ride requests from Cam, Dan, Eric, Fred, and James, respectively. The second processor 218 further determines the first score by performing a summation of the first through sixth probabilities. The first score indicates the probability of matching Adam with at least one of Brad, Cam, Dan, Eric, Fred, or James for the share-ride.

At step 508, the second score is determined based on count of available vehicles for the share-ride. The second score indicates a probability of vehicles available for the share-ride. In the example, the second processor 218 determines the second score.

At step 510, the third score is determined based on the first and second scores. The third score indicates the probability of matching the first passenger with at least one passenger for sharing the selected vehicle. In the example, the second processor 218 determines a third score based on the first and second scores. The third score indicates the probability of matching Adam with at least one of Brad, Cam, Dan, Eric, Fred, or James for sharing the selected vehicle.

At step 512, the share-ride discount is determined based on at least one of the third score, the historical share-rides associated with the one or more routes, the count of share-ride demand, and the different time durations of the day. In the example, the share-ride discount for Adam to travel with at least one of Brad, Cam, Dan, Eric, Fred, or James depends on the third score, the historical share-rides associated with the one or more routes connecting the ‘X’ and ‘Y’ locations, the count of share-ride demand, and the historical share-rides associated with different time durations of the day.

At step 514, the share-ride fare is determined based on one of the share-ride discount and the fixed ride fare. In the example, the second processor 218 determines the share-ride fare for Adam based on one of the share-ride discount for Adam or the fixed ride fare for Adam.

At step 516, the user interface 210 is rendered on the display 208 of the passenger device 102. The user interface 210 presents various options selectable by the first passenger, the share-ride fare, the share-ride discount, the pick-up time, and the like. The options include the ‘confirm’ and ‘reject’ tabs 406a and 406b to accept and reject the share-ride fare for the share-ride, respectively. The first passenger selects one of the options, and the selected option is transmitted to the second processor 218. In the example, Adam may select the ‘confirm’ tab 406a to accept the share-ride fare. In another example, Adam may select the ‘reject’ tab 406b to reject the share-ride fare.

At step 518, a response, i.e., the selected option is received from the first passenger by way of the second transceiver 220 over the communication network 110. Based on the selected option, the second processor 218 performs one or more defined operations. In the example, the second processor 218 receives the option selected by Adam.

At step 520, the selected vehicle is allocated to the first passenger based on confirmation response. In the example, the selected vehicle is allocated to Adam for the share-ride.

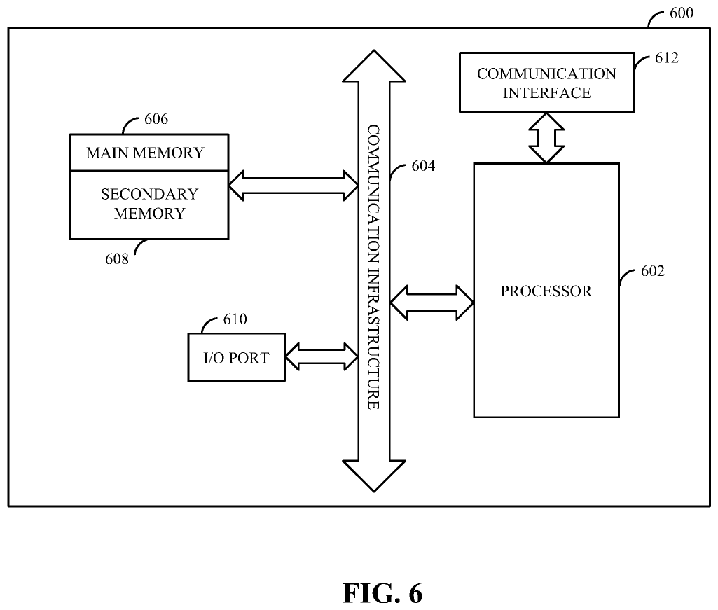

FIG. 6 is a block diagram that illustrates a computer system 600 for determining a share-ride fare in the ride-sharing system, in accordance with an embodiment of the present invention. An embodiment of the present invention, or portions thereof, may be implemented as computer readable code on the computer system 600. In one example, the database server 106 and the application server 108 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 5A and 5B.

The computer system 600 includes a processor 602 that may be a special purpose or a general-purpose processing device. The processor 602 may be a single processor, multiple processors, or combinations thereof. The processor 602 may have one or more processor “cores.” Further, the processor 602 may be connected to a communication infrastructure 604, such as a bus, a bridge, a message queue, the communication network 110, multi-core message-passing scheme, and the like. The computer system 600 further includes a main memory 606 and a secondary memory 608. Examples of the main memory 606 may include random-access memory (RAM), read-only memory (ROM), and the like. The secondary memory 608 may include a hard disk drive or a removable storage drive (not shown), such as a floppy disk drive, a magnetic tape drive, a compact disc, an optical disk drive, a flash memory, and the like. Further, the removable storage drive may read from and/or write to a removable storage device in a manner known in the art. In an embodiment, the removable storage unit may be a non-transitory computer readable recording media.

The computer system 600 further includes an input/output (I/O) port 610 and a communication interface 612. The I/O port 610 includes various input and output devices that are configured to communicate with the processor 602. Examples of the input devices may include a keyboard, a mouse, a joystick, a touchscreen, a microphone, and the like. Examples of the output devices may include a display screen, a speaker, headphones, and the like. The communication interface 612 may be configured to allow data to be transferred between the computer system 600 and various devices that are communicatively coupled to the computer system 600. Examples of the communication interface 612 may include a modem, a network interface, i.e., an Ethernet card, a communications port, and the like. Data transferred via the communication interface 612 may be signals, such as electronic, electromagnetic, optical, or other signals as will be apparent to a person skilled in the art. The signals may travel via a communications channel, such as the communication network 110 which may be configured to transmit the signals to the various devices that are communicatively coupled to the computer system 600. Examples of the communication channel may include, but not limited to, cable, fiber optics, a phone line, a cellular phone link, a radio frequency link, a wireless link, and the like.

Computer program medium and computer usable medium may refer to memories, such as the main memory 606 and the secondary memory 608, which may be a semiconductor memory such as dynamic RAMs. These computer program mediums may provide data that enables the computer system 600 to implement the methods illustrated in FIGS. 5A and 5B. In an embodiment, the present invention is implemented using a computer implemented application. The computer implemented application may be stored in a computer program product and loaded into the computer system 600 using the removable storage drive or the hard disc drive in the secondary memory 608, the 10 port 610, or the communication interface 612.

A person having ordinary skill in the art will appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor, such as the processor 602, and a memory, such as the main memory 606 and the secondary memory 608, implement the above described embodiments. Further, the operations may be described as a sequential process, however some of the operations may in fact be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Specific advantages of the method and the system include determining a share-ride fare for the first passenger of getting the first passenger matched with at least the second passenger for the share-ride, provided the vehicles are available for the share-ride. Thus, if the first passenger is travelling along a route that has a low probability of finding another passenger for sharing the selected vehicle, the method and the system of the present invention ensures that the first passenger is charged a higher share-ride as compared to when travelling along a route that has a high probability of finding another passenger for sharing the selected vehicle. Hence, the first passenger will be charged for the share-ride based on the overall ride experience that the first passenger is about to receive during the share-ride, i.e., whether the first passenger will be travelling alone during the share-ride or will be matched with at least one passenger. Further, such charging for the share-ride may ensure that the transport service provider or the driver does not incur a loss in the ride-sharing system. The method and the system of the present invention further consider the count of historical share-rides for determining the share-ride discount. Thus, the transport service provider may provide additional share-ride discount to the first passenger if the first passenger is travelling along a route that has a low number of historical share-rides and the transport service provider wishes to promote the route having the low number of historical share-rides or a geographical area associated with the route having the low number of historical share-rides. The method and the system of the present invention further considers the count of the share-ride demand for determining the share-ride discount. Thus, the transport service provider may provide additional share-ride discount to passengers booking the share-ride if the share-ride demand is less than the target demand. Thus, the method and the system provide an efficient way of charging passengers in the ride-sharing system.

Techniques consistent with the present invention provide, among other features, systems and methods for ride-sharing. Unless stated otherwise, terms such as “first” and “second” are used to arbitrarily distinguish between the elements such terms describe. Thus, these terms are not necessarily intended to indicate temporal or other prioritization of such elements. While various exemplary embodiments of the disclosed system and method have been described above it should be understood that they have been presented for purposes of example only, not limitations. It is not exhaustive and does not limit the invention to the precise form disclosed. Modifications and variations are possible in light of the above teachings or may be acquired from practicing of the invention, without departing from the breadth or scope.

What is claimed is:

1. A method for vehicle allocation, the method comprising:
receiving, by circuitry over a communication network, a share-ride request including at least source and destination locations for a share-ride from a passenger device of a first passenger;
determining, by the circuitry, a first score based on at least historical and real-time signals associated with one or more routes including the source and destination locations, wherein the first score indicates matching of the first passenger with at least a second passenger for the share-ride;
determining, by the circuitry, a second score based on a count of vehicles available for the share-ride requested by the first passenger;
determining, by the circuitry, a share-ride discount for the share-ride based on at least the first and second scores; and
allocating, by the circuitry, a vehicle selected from the available vehicles to the first passenger for the share-ride based on a confirmation of a share-ride fare, including at least the share-ride discount, for the share-ride provided by the first passenger.

2. The method of claim 1, wherein the historical signals include at least historical share-ride requests associated with the one or more routes, and wherein the real-time signals include at least one of real-time share-ride requests associated with the one or more routes, real-time traffic conditions associated with the one or more routes, or different time durations of a day.

3. The method of claim 1, further comprising determining, by the circuitry, a third score based on the first and second scores, wherein the third score indicates matching of the first passenger with at least the second passenger for sharing the selected vehicle.

4. The method of claim 3, wherein the share-ride discount is higher when the third score is greater than a threshold value in comparison to the share-ride discount when the third score is less than the threshold value.

5. The method of claim 1, wherein the share-ride discount is further determined based on historical share-rides associated with the one or more routes.

6. The method of claim 1, wherein the share-ride discount is further determined based on a count of share-ride demand, and wherein the share-ride discount is higher when the count of the share-ride demand is less than a target demand in comparison to the share-ride discount when the count of the share-ride demand is more than the target demand.

7. The method of claim 1, wherein the share-ride discount is further determined based on historical share-rides associated with different time durations of a day, and wherein the share-ride discount for a first time duration of the day is greater than the share-ride discount for a second time duration of the day, when a count of the historical share-rides during the first time duration of the day is less than a count of the historical share-rides during the second time duration of the day.

8. The method of claim 1, wherein the share-ride fare further includes a fixed ride fare for the share-ride that is determined based on at least a distance between the source and destination locations and real-time traffic conditions between the source and destination locations, and wherein the real-time traffic conditions are determined based on sensor data received from at least one of location sensing devices or image sensing devices.

9. The method of claim 1, further comprising rendering, by the circuitry, a user interface on the passenger device for presenting share-ride information of the share-ride comprising at least the share-ride fare.

10. The method of claim 9, wherein the user interface further presents a plurality of options including at least first and second options, and wherein
the first option is selectable by the first passenger to confirm the share-ride fare for the share-ride, and
the second option is selectable by the first passenger to reject the share-ride fare for the share-ride.

11. A system for vehicle allocation, the system comprising:
circuitry configured to:
receive a share-ride request including at least source and destination locations for a share-ride from a passenger device of a first passenger over a communication network;
determine a first score based on at least historical and real-time signals associated with one or more routes including the source and destination locations, wherein the first score indicates matching of the first passenger with at least a second passenger for the share-ride;
determine a second score based on a count of vehicles available for the share-ride requested by the first passenger;
determine a share-ride discount for the share-ride based on at least the first and second scores; and
allocate a vehicle selected from the available vehicles to the first passenger for the share-ride based on a confirmation of a share-ride fare, including at least the share-ride discount, for the share-ride provided by the first passenger.

12. The system of claim 11, wherein the historical signals include at least historical share-ride requests associated with the one or more routes, and wherein the real-time signals include at least one of real-time share-ride requests associated with the one or more routes, real-time traffic conditions associated with the one or more routes, or different time durations of a day.

13. The system of claim 11, wherein the circuitry is further configured to determine a third score based on the first and second scores, and wherein the third score indicates matching of the first passenger with at least the second passenger for sharing the selected vehicle.

14. The system of claim 13, wherein the share-ride discount is higher when the third score is greater than a threshold value in comparison to the share-ride discount when the third score is less than the threshold value.

15. The system of claim 11, wherein the circuitry is further configured to determine the share-ride discount based on historical share-rides associated with the one or more routes.

16. The system of claim 11, wherein the share-ride discount is further determined based on a count of share-ride demand, and wherein the share-ride discount is higher when the count of the share-ride demand is less than a target demand in comparison to the share-ride discount when the count of the share-ride demand is more than the target demand.

17. The system of claim 11, wherein the circuitry is further configured to determine the share-ride discount based on historical share-rides associated with different time durations of a day, wherein the share-ride discount for a first time duration of the day is greater than the share-ride discount for a second time duration of the day, when a count of the historical share-rides during the first time duration of the day is less than a count of the historical share-rides during the second time duration of the day.

18. The system of claim 11, wherein the share-ride fare further includes a fixed ride fare for the share-ride that is determined based on at least a distance between the source and destination locations and real-time traffic conditions between the source and destination locations, wherein the real-time traffic conditions are determined based on sensor data received from at least one of location sensing devices or image sensing devices.

19. The system of claim 11, wherein the circuitry is further configured to render a user interface on the passenger device for presenting share-ride information of the share-ride comprising at least the share-ride fare, wherein the user interface further presents a plurality of options including at least first and second options, and wherein
the first option is selectable by the first passenger to confirm the share-ride fare for the share-ride, and
the second option is selectable by the first passenger to reject the share-ride fare for the share-ride.
